(19) United States
(12) Patent Application Publication
(10) Pub. No.: US 2003/0043121 A1
(43) Pub. Date: Mar. 6, 2003

(54) Multimedia pointing device

(76) Inventor: Richard Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/860,862

(22) Filed: May 22, 2001

(51) Int. Cl. G09G 5/00

(52) U.S. Cl. 345/169

(57) ABSTRACT

A multimedia pointing device comprises a computer keyboard unit and a shuttle dial arranged on a keyboard of the computer keyboard unit. The shuttle dial is connected to a single-chip microprocessor in the computer keyboard unit and generates a pulse or a pulse train upon being activated by pressing and rotation operation. The single-chip microprocessor detects the number and phase of the pulse or the pulse train and encodes the detection result to scan code stored in a driver. By invoking the WINExec 0 function of the Windows system; a plurality of icons corresponding to application programs associated with the scan codes are displayed on the display monitor. The switch is operated to control cursor, scroll bar and numbers under Windows environments; and the program selection and execution is also facilitated.

### FIELD OF THE INVENTION

The present invention relates to a multimedia pointing device, especially to a multimedia pointing device to control cursor on a display screen of computer peripheral.

### BACKGROUND OF THE INVENTION

FIG. 1 shows a partially perspective view of a prior art standard keyboard. The prior art keyboard is incorporated with a plurality of multimedia hot keys 60 such as WWW, e-mail, mute, close, dos, volume up, calculator, volume down, and play etc. for user's convenience. Those multimedia hot keys 60 have specific scan codes. The Windows application can hook the specific scan codes and the specific scan codes are interpreted through a driver. When user presses down a hot key, the specific function associated with the hot key is automatically executed. Therefore, user can quickly access specific program without involving a mouse.

However, as the multimedia functions associated with computer become complicated, the number of hot keys is increased. The plurality of hot keys occupies considerable space on keyboard. The finding and identifying the hot keys is also a cumbersome problem to user.

### SUMMARY OF THE INVENTION

It is an object of the present invention to provide a shuttle dial for multimedia application. The shuttle dial is rotated and pressed to control cursor, scroll bar and numbers under Windows environments; and the program selection and execution is also facilitated. The shuttle dial can be advantageously used to replace the existing hot keys on keyboard.

It is another object of the present invention to provide a multimedia pointing device to augment the function of existing hot keys on keyboard and provide more convenience.

The various objects and advantages of the present invention will be more readily understood from the following detailed description when read in conjunction with the appended drawing, in which:

### BRIEF DESCRIPTION OF DRAWING

FIG. 1 shows a partially perspective view of a prior art standard keyboard;

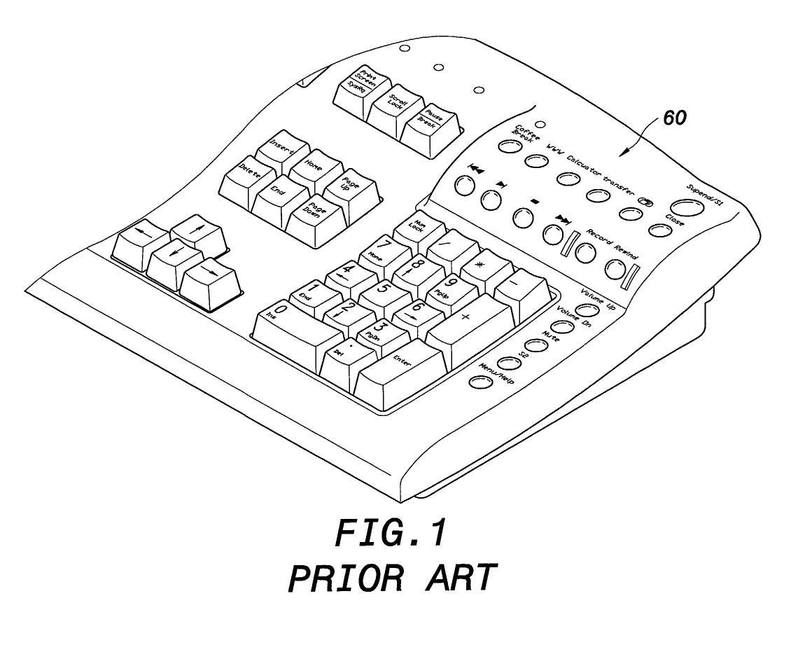

FIG. 2 shows the first preferred embodiment of the present invention;

FIG. 3 shows the operational display of the multimedia pointing device applied in computer;

FIG. 4 shows the operational display of the multimedia pointing device applied in notebook computer;

FIG. 5 shows the waveform of the shuttle dial;

FIG. 6 is the block diagram of the present invention;

FIG. 7 is the circuit diagram of the present invention;

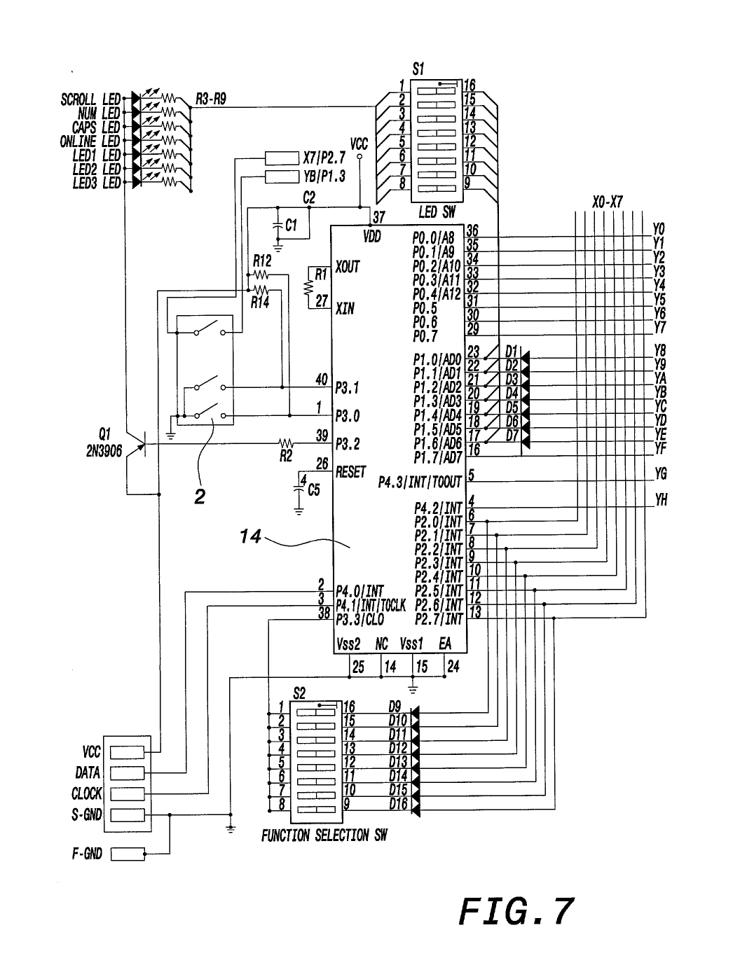

FIG. 8 shows the second preferred embodiment of the present invention;

FIG. 9 shows the third preferred embodiment of the present invention;

FIG. 10 shows the fourth preferred embodiment of the present invention.

### DETAILED DESCRIPTION OF THE INVENTION

The multimedia pointing device according to the present invention is arranged on computer keyboard unit, notebook computer or personal digital assistant to control cursor, scroll bar and numbers on a display screen.

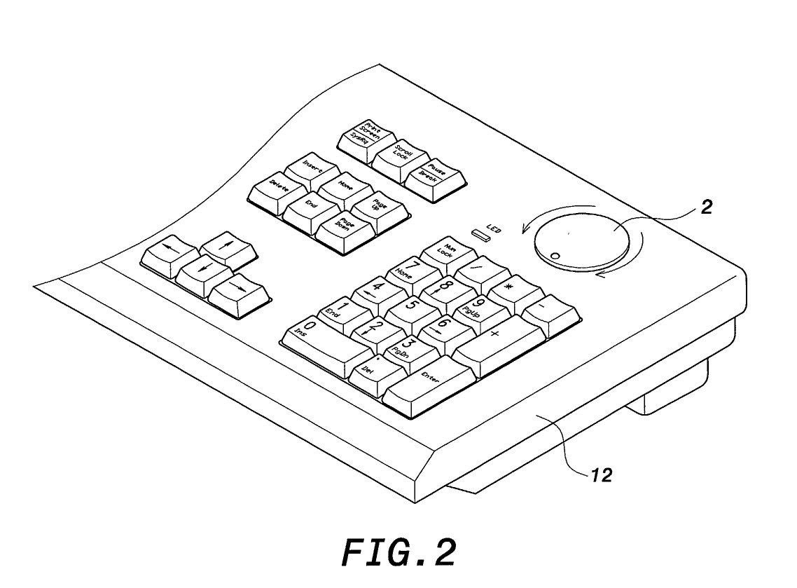

With reference now to FIGS. 2 to 6, the multimedia pointing device according to the first preferred embodiment of the present invention comprises a keyboard unit 1 and a shuttle dial 2.

The keyboard unit 1 comprises a computer main frame 11, a keyboard 12 and a monitor 13. The keyboard 12 has a single-chip microprocessor 14 therein.

The shuttle dial 2 is arranged atop the numeric keypad on right side of the keyboard 12 and is connected to the I/O lines of the I/O ports of the single-chip microprocessor 14. In the first preferred embodiment of the present invention, the shuttle dial 2 is connected to an I/O line P1.3 of the first I/O port of the single-chip microprocessor 14, an I/O line P2.7 of the second I/O port of the single-chip microprocessor 14 and two I/O lines P3.0 and P3.1 of the third I/O port of the single-chip microprocessor 14.

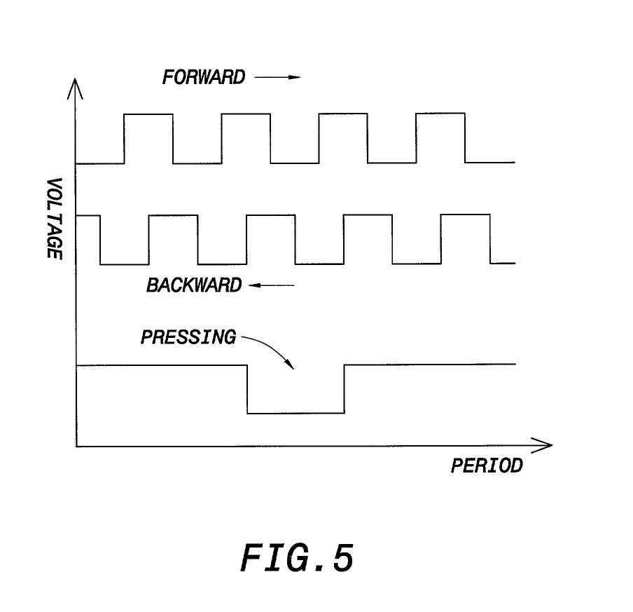

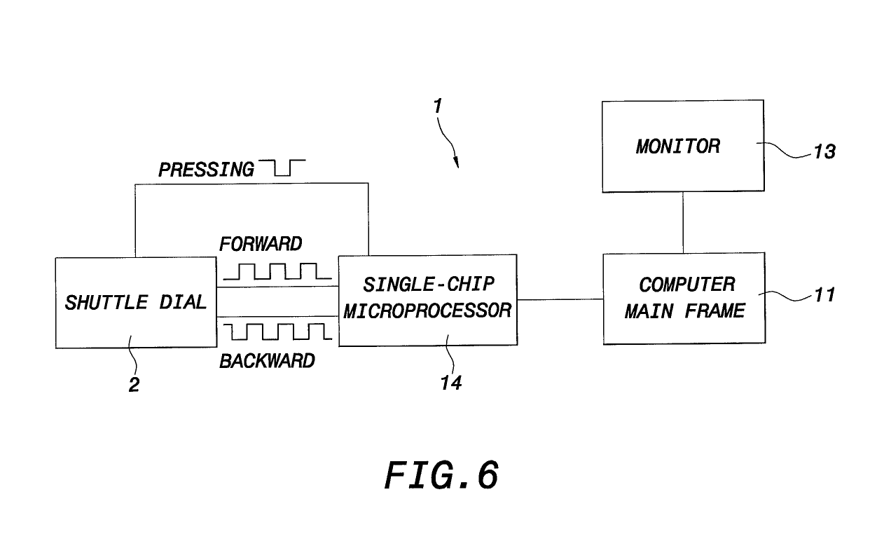

As shown in FIG. 5 and 6, the shuttle dial 2 can generate a single pulse or a pulse train, depending on the pressing, forward dialing and backward dialing operation thereof. Moreover, the shuttle dial 2 generates pulse trains with different phases for the forward dialing and backward dialing operations. The single-chip microprocessor 14 can discriminate the pressing, forward dialing and backward dialing operation of the shuttle dial 2 by the number and phase of the pules signal and interpret the operation by a scan code stored in a driver. The scan codes stored in the driver each is corresponding to a specific application program. The WINExec 0 function of the Windows system is invoked; and the paths and the filenames of the application programs are input as arguments of the WINExec 0 function such that a plurality of icons representing the applications program are displayed on monitor. The shuttle dial 2 is operated to select specific icon from the monitor.

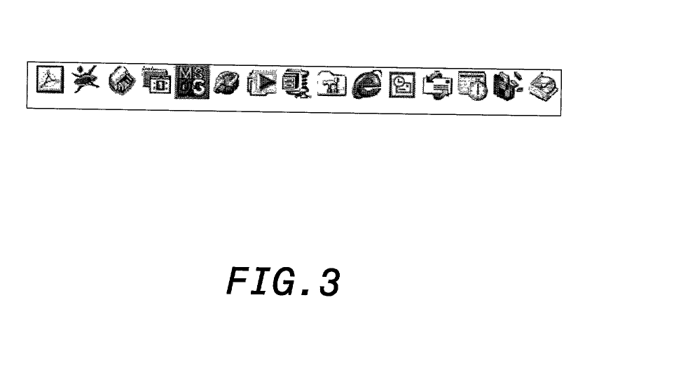

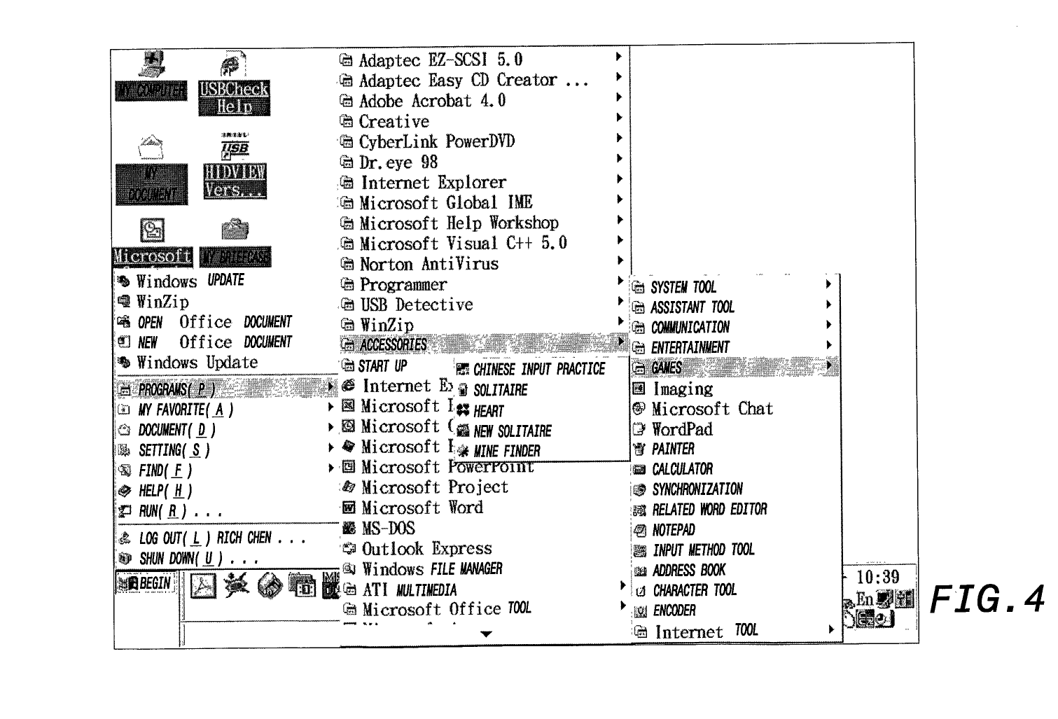

When user starts to rotate the shuttle dial 2, the computer monitor 13 displays the screen as shown in FIGS. 3 and 4. When user continues to rotate the shuttle dial 2, a highlighted bar is moved orderly through the icons. If the user want to execute the program associated with the icon where the highlighted bar is stayed, he only needs to press the shuttle dial 2 immediately. If user stops moving the shuttle dial 2 for 2 to 3 seconds, the screen is automatically cleared.

Therefore, by operating the keyboard 12 equipped with the shuttle dial 2, user can press or rotate the shuttle dial 2 to control cursor, scroll bar and numbers under Windows environments. The keyboard 12 equipped with the shuttle dial 2 facilitates program selection and execution for user with the help of Windows system or other operation system, and advantageously replaces the functions of hot keys.

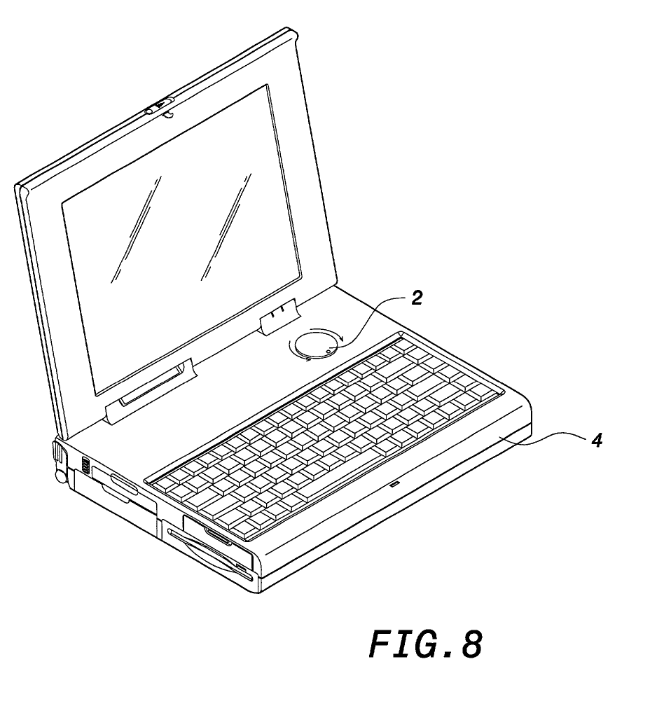

FIG. 8 shows the second preferred embodiment of the present invention, wherein the shuttle dial 2 is provided on a notebook computer 4 to replaced the hot keys on a multimedia keyboard.

When user starts to rotate the shuttle dial 2, the notebook computer 4 displays the screen as shown in FIGS. 3 and 4. When user continues to rotate the shuttle dial 2, a highlighted bar is moved orderly through the icons. If the user want to execute the program associated with the icon where the highlighted bar is stayed, he only needs to press the shuttle dial 2 immediately. If user stops moving the shuttle dial 2 for 2 to 3 seconds, the screen is automatically cleared.

Therefore, by operating the notebook computer 4 equipped with the shuttle dial 2, user can press or rotate the shuttle dial 2 to control cursor, scroll bar and numbers under Windows environments. The notebook computer 4 equipped with the shuttle dial 2 facilitates program selection and execution for user with the help of Windows system or other operation system, and advantageously replaces the functions of hot keys.

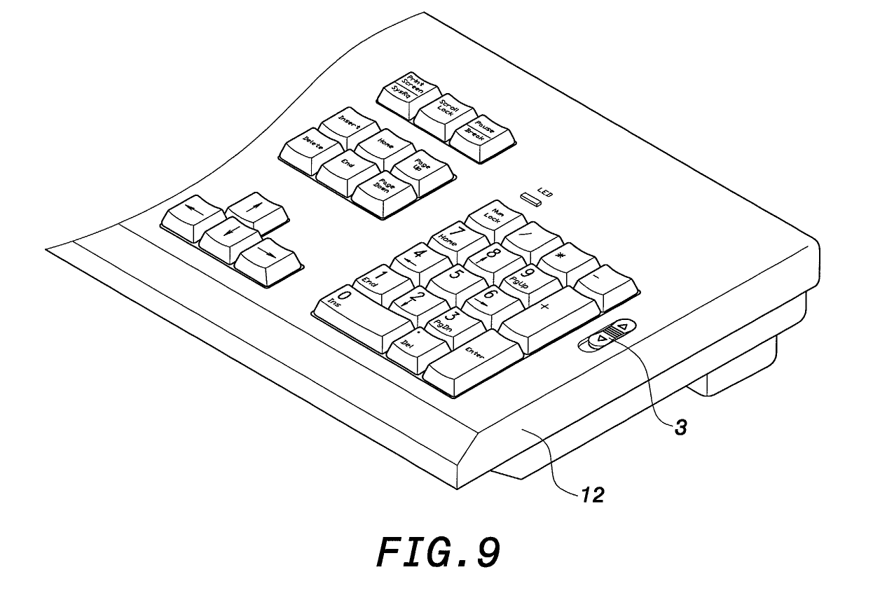

FIG. 9 shows the third preferred embodiment of the present invention, wherein a sliding key 3 is provided on the keyboard 12 in stead of the shuttle dial 2 to select and execute program icons. The sliding key 3 is connected to the single-chip microprocessor 14 provided in the keyboard unit 1.

The sliding key 3 generates a single pulse or a pulse train when being pressed or pushed laterally. The single-chip microprocessor 14 can discriminate the pressing or the sliding direction operation of the sliding key 3 by the number and phase of the pules signal and interpret the operation by a scan code stored in a driver. The scan codes stored in the driver each is corresponding to a specific application program. The WINExec 0 function of the Windows system is invoked; and the paths and the filenames of the application programs are input as arguments of the WINExec 0 function such that a plurality of icons representing the applications program are displayed on monitor. The sliding key 3 is operated to select specific icon from the monitor.

When the sliding key 3 is pressed upward (or rightward), the highlighted bar is moved in one direction through the displayed icons. On the contrary, when the sliding key 3 is pressed downward (or leftward), the highlighted bar is moved in another direction through the displayed icons. Therefore, user can move the highlighted bar to select desired icon by operating the sliding key 3 and press the sliding key 3 to execute the program associated with the icon. If user stops moving the shuttle dial 2 for 2 to 3 seconds, the screen is automatically cleared.

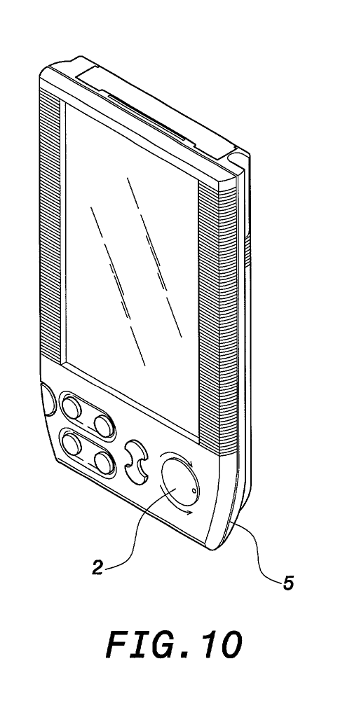

FIG. 10 shows the fourth preferred embodiment of the present invention, wherein the shuttle dial 2 is provided on a personal digital assistant (PDA) 5 to replaced the hot keys on a multimedia keyboard. The shuttle dial 2 is connected to a single-chip microprocessor (not shown) provided in the personal digital assistant (PDA) 5.

When user starts to rotate the shuttle dial 2, the personal digital assistant 5 displays the screen as shown in FIGS. 3 and 4. When user continues to rotate the shuttle dial 2, a highlighted bar is moved orderly through the icons. If the user want to execute the program associated with the icon where the highlighted bar is stayed, he only needs to press the shuttle dial 2 immediately. If user stops moving the shuttle dial 2 for 2 to 3 seconds, the screen is automatically cleared.

Therefore, by operating the personal digital assistant 5 equipped with the shuttle dial 2, user can press or rotate the shuttle dial 2 to control cursor, scroll bar and numbers under Windows environments. The personal digital assistant 5 equipped with the shuttle dial 2 facilitates program selection and execution for user with the help of Windows system or other operation system, and advantageously replaces the functions of hot keys.

I claim

1. A multimedia pointing device, comprising
a computer peripheral with a display monitor and containing a single-chip microprocessor with at least one I/O port;
a switch activated by pressing, rotation or lateral-shift operation, and arranged on the computer peripheral and connected to the I/O port of the single-chip microprocessor; the switch generating a pulse or a pulse train upon being activated by pressing, rotation or lateral-shift operation; the single-chip microprocessor detecting the number and phase of the pulse or a pulse train and judging the moved direction and operation type of the switch and encoding the judging result to a scan code stored in a driver;
by the WINExec 0 function of the Windows system; a plurality of icons corresponding to application programs associated with the scan codes being displayed on the display monitor; the switch being operated to control cursor, scroll bar and numbers under Windows environments; the program selection and execution being also facilitated.

2. The multimedia pointing device as in claim 1, wherein the computer peripheral can be computer keyboard unit, notebook computer or personal digital assistant.

3. The multimedia pointing device as in claim 1, wherein the switch is a shuttle dial or a sliding key.

4. The multimedia pointing device as in claim 1, wherein the switch is connected to an I/O line of a first I/O port of the single-chip microprocessor, an I/O line of a second I/O port of the single-chip microprocessor and two I/O lines of a third I/O port of the single-chip microprocessor.
